(19) United States
(12) Patent Application Publication
(10) Pub. No.: US 2015/0158269 A1
(43) Pub. Date: Jun. 11, 2015

(54) NATURAL FIBER POLYMER COMPOSITE AND ECO-FRIENDLY LIGHTWEIGHT BASE MATERIAL FOR AUTOMOTIVE INTERIOR

(71) Applicant: HANIL E-HWA CO., LTD., SEOUL (KR)

(72) Inventors: Ki-Sung KIM, Asan-si Chungcheongnam-do (KR); Sang-Gyu JI, Asan-si Chungcheongnam-do (KR)

(21) Appl. No.: 14/555,968

(22) Filed: Nov. 28, 2014

(30) Foreign Application Priority Data
Dec. 5, 2013 (KR) 10-2013-0150824
Aug. 11, 2014 (KR) 10-2014-0103366

(51) Int. Cl. B32B 5/02; B32B 38/00; B29C 70/42; D04H 1/10; B32B 5/24

(52) U.S. Cl. CPC B32B 5/022; D04H 1/10; B32B 5/245; B29C 70/42; B32B 38/0032; B32B 2255/02; B32B 2260/046; B32B 2255/26; B32B 2262/14; B32B 2307/718; B32B 2307/734; B32B 2307/712; B32B 2307/546; B32B 2605/003; B29K 2001/00

(57) ABSTRACT

The present invention relates to an eco-friendly lightweight substrate material for the automotive interior, characterized in that isocyanate or epoxy is added to enhance the function of a substrate material having a sandwich-type structure for the automotive interior including natural fiber that is vulnerable to high temperature and humidity conditions, preventing degradation of physical properties by water-impregnation into the natural fiber and thus enhancing the humidity-resistance and strength of a natural fiber reinforcing layer; and the substrate material is continuously prepared in a thermoplastic foam sheet core layer by thermal-laminating. The substrate material prepared according to the present invention is an eco-friendly material, also is capable of weight lightening by weight reduction, and is excellent in humidity-resistance and strength, thus providing for application to various industries such as train interior, aircraft interior, and architectural interior as well as automotive interior.

This application claims the benefit of Korean Patent Application No. 2013-0150824, filed on Dec. 05, 2013 and Korean Patent Application No. 2014-0103366, filed on Aug. 11, 2014, which is hereby incorporated by reference as if fully set forth herein.

### TECHNICAL FIELD

The present invention relates to a natural fiber polymer composite and an eco-friendly lightweight substrate material for the automotive interior.

### BACKGROUND

A substrate material for the automotive interior is required to maintain dimensional stability and physical properties at various temperatures and humidities, since the material is an automotive part in direct contact with passengers, and performs a role of protecting passengers from external environments, maintaining a form for which a plurality of components is configured. In addition, due to recent issues, such as environmental pollution and global warming, there is a further need of eco-friendly material use and weight lightening for enhancing fuel efficiency.

Generally, a substrate material for the automotive interior has a sandwich-type structure, in which reinforcing layers are stacked on one or both sides of a core layer, where, previously, a thermosetting phenol resin impregnated in a glass fiber felt as a reinforcing layer and a polyurethane foam sheet as a core layer, are mainly used.

However, a glass fiber felt for use in a reinforcing layer has drawbacks, in that dust particles generated from preparation are harmful to the human body, nearly non-solubility in natural environments causes resulting wastes to pollute the environments, and a phenol resin used as a binder is also nearly insoluble and difficult to recycle, thus is not eco-friendly. Furthermore, these materials have levels of high density, which may lead to a decrease in fuel efficiency caused by an increase in weight when applied to automotive parts. In addition, since a polyurethane foam sheet for use in a core layer is not heat-melting, there is a need of additional processes, such as applying an adhesive when stacking a reinforcing layer or applying a hot-melt film, resulting in disadvantages such as complicated and cost-consuming processes.

Recently, in order to resolve the above-mentioned problems, use of natural fiber as a reinforcing layer and a foam sheet as a core layer has been introduced, which contributed to excellence in weight lightening and eco-friendliness of a substrate material when used at room temperature, however, still has drawbacks in relation to form stability, such as, distortion or deflection of a substrate material in high temperature and humidity conditions, due to drawbacks of natural fiber having poor water-resistance.

Accordingly, several studies concerning pre-treatment methods for enhancing water-resistance of natural fiber, such as electronic beam radiation, plasma radiation, alkali treatment, and silane treatment, have been carried out to resolve these drawbacks, however, still have limitations in application to industrial processes, due to high levels of process set-up expense consumption for pre-treatment and requirement of additional processing time.

### SUMMARY

As described above, an object of the present invention is to provide a method for preparing a substrate material for the automotive interior, which has excellence in lightweightness and enhancement in humidity-resistance and strength of a natural fiber reinforcing layer using isocyanate, and thus in deflection of a substrate material and degradation of physical properties, in order to resolve drawbacks of known substrate materials for the automotive interior having a sandwich-type structure including natural fiber, such as deflection of a substrate material and degradation of physical properties in high temperature and humidity conditions.

An object of the present invention is to provide a method for preparing a substrate material for the automotive interior, which has excellence in humidity-resistance and lightweightness using an eco-friendly material, comprising applying isocyanate on a felt consisting essentially of natural fiber and synthetic fiber, to prepare a thin film reinforcing layer having enhanced humidity-resistance, and continuously thermal-laminating it on a thermoplastic foam sheet.

To achieve the above object, the present invention provides a method for preparing a substrate material for the automotive interior, having enhanced humidity-resistance, characterized in four steps including, a first step of preparing a felt using natural fiber and synthetic fiber; a second step of applying liquid isocyanate on the felt and then carrying out semi-curing reaction using a hot-working pressing roller to prepare a sheet; a third step of applying thermoplastic polymer powder on the sheet and then completing the formation of a thermoplastic polymer powder layer and curing reaction by passing through a hot-working oven to prepare a thin film reinforcing layer using the pressing roller; and a forth step of continuously stacking the prepared thin film reinforcing layer on one or both sides of a core layer consisting essentially of a thermoplastic foam sheet in a thermal-laminating process to prepare a substrate material.

In addition, the present invention provides a method for preparing a substrate material for the automotive interior, having enhanced humidity-resistance, characterized in four steps including, a first step of mixing natural fiber and synthetic fiber by carding to prepare a felt via web-forming and needle-punching processes; a second step of applying or impregnating isocyanate or epoxy on the felt to mold in a semi-cured state using a hot-working pressing roller at the temperature of 150° C. to 250° C., to prepare a sheet by pressing; a third step of applying thermoplastic powder of 10 g/m² and 100 g/m² on the sheet and passing it through a hot-working oven at the temperature of 150° C. to 250° C., and then pressing it on a hot-working roll to prepare a thin film reinforcing layer; and a forth step of continuously stacking the prepared thin film reinforcing layer on a thermoplastic foam sheet in a thermal-laminating process to prepare a substrate material.

In an embodiment according to the present invention, it is preferred that the thermoplastic foam sheet consists essentially of polypropylene, polyethylene, or polyester; the foaming magnification of the sheet is 5 to 40 times; and the thickness of the sheet is 2 to 10 mm.

In an embodiment according to the present invention, it is preferred that the isocyanate is methylene diphenyl di-isocyanate (MDI) or toluene di-isocyanate (TDI).

In an embodiment according to the present invention, it is preferred that the weight of the isocyanate impregnated in the natural fiber thin film reinforcing layer is 5 g/m² to 100 g/m².

In an embodiment according to the present invention, it is preferred that isocyanate or epoxy incorporated in the thin film reinforcing layer is added in a manner of a spraying process or impregnating in a roll.

In an embodiment according to the present invention, it is preferred that the thickness of thin film reinforcing layer is 0.5 to 2 mm; and the weight of the layer is 120 g/m² to 700 g/m².

In an embodiment according to the present invention, it is preferred that one or more synthetic fibers for use in the thin film reinforcing layer are selected from polypropylene fiber of 30-100 mm in length, core-sheath low melting point polyester fiber, polyester fiber, polyethylene fiber, acryl fiber, or biodegradable fiber.

In addition, it is preferred that the content of synthetic fiber for use in the thin film reinforcing layer is 30-70% by weight.

In addition, it is preferred that one or more natural fibers for use in the thin film reinforcing layer are selected from kenaf of 30-100 mm in length, jute, linum, bamboo, or sisal.

In addition, it is preferred that the content of natural fiber for use in the thin film reinforcing layer is 30-70% by weight.

In addition, it is preferred that one or more for use in the thermoplastic powders are selected from low-density polyethylene, high-density polyethylene, or polypropylene.

In addition, according to the present invention, it is preferred that the weight of an eco-friendly lightweight substrate material having excellent humidity-resistance is 300 g/m² to 1500 g/m².

The present invention also provides an eco-friendly lightweight substrate material for the automotive interior having enhanced humidity-resistance, prepared by the above-described preparing methods, characterized in that a film reinforcing layer is thermal-laminated on one or both sides of a core material consisting essentially of a thermoplastic foam sheet; liquid isocyanate is applied or impregnated on a felt; the film reinforcing layer is then semi-cured using a hot-working pressing roller on the surface of felt layers of natural fiber and synthetic fiber; and after applying thermoplastic powder, a thermoplastic powder layer is formed and curing reaction of isocyanate or epoxy is completed by passing through a hot-working oven.

In addition, the present invention further provides an eco-friendly lightweight substrate material for the automotive interior having enhanced humidity-resistance, characterized in that a humidity-resistance flexural rigidity is greater than 1.0 kgf/5 cm, and a humidity-resistance deflection extent (L) is equal to, or less than 2.0 by the following standards,
(where the humidity-resistance flexural rigidity (kgf/5 cm) is the measured value, regarding a specimen of “50 mm×150 mm×thickness” and “660 g/m²” in weight, calculated based on ASTM D790 after allowing the specimen for 24 hours at the testing rate of 5 mm/min, the span width of 100 mm, 50° C., and 95 RH % humidity, and then stabilizing it for an hour at 23° C. and 95 RH % humidity.
and where the humidity-resistance deflection extent (L) is measured by fixating 70 mm in the distal end of a specimen of “50 mm×150 mm×thickness” and “660 g/m²” in weight; placing a weight of 40 mm×60 mm in size and 34.2 g in weight on the opposite part; and measuring the difference between an initial height (L1) from the bottom to the lower part of the specimen and a subsequent height (L2) measured after allowing the specimen for 7 hours at 50° C. and 95 RH % humidity (i.e. L=L1−L2))

As described in the above, an eco-friendly lightweight substrate material for the automotive interior according to the present invention has advantages achieved by substituting glass fiber for use in conventional automotive industry with natural fiber, to provide an eco-friendly material that is not harmful to the human body, and applying a thermal-laminating process without using an adhesive or hot-melt film used in bonding a foam sheet and a reinforcing layer to provide a simple, less cost-consuming process and unharmful working environments. Furthermore, applying isocyanate (or epoxy) to a natural fiber reinforcing layer in a simple and less cost-consuming process, has effects in remarkably enhancing deflection, distortion, and degradation of physical properties in high temperature and humidity conditions that the known natural-fiber containing substrate materials for the automotive interior having a sandwich-type structure used to have, thus providing for application to various industries such as train interior, aircraft interior, and architectural interior as well as automotive interior.

In addition, a method according to the present invention has effects in providing for less cost-consuming preparation, since only a simple process is needed to be added to known preparation processes, minimizing cost burden such as additional facilities for preparation at a lower cost.

### BRIEF DESCRIPTION OF THE FIGURES

FIG. 1 shows a graph showing the difference in tensile strengths of a natural fiber polymer composite prior to and after application of isocyanate.

FIG. 2 shows a graph showing surface morphologies of a natural fiber polymer composite prior to and after application of isocyanate, over humidity-resistance time.

FIG. 3 shows a graph showing the changes in tensile strengths of a natural fiber polymer composite prior to and after application of isocyanate, over humidity-resistance time.

FIG. 4 shows configuration of an eco-friendly lightweight substrate material for the automotive interior, according to an example of the present invention.

### DETAILED DESCRIPTION

Since the examples discussed below are intended to simply describe application effects of the present invention in detail, these are purely exemplary of the present invention and should not be considered to limit the invention in any way.

First, the following explanation of a natural fiber polymer composite is provided.

[Materials]
1. isocyanate: 4,4′-methylenediphenyl diisocyanate (Pyusis Corp.)
2. natural fiber: kenaf (average diameter : 70 μm, length: 60-80 mm)
3. thermoplastic polymer: polypropylene (Hankuk Fiber Corp. diameter: 6 D, length: 51 mm), polyester fiber (Woongjin Chemical Corp. diameter: 6 D, length: 51 mm)

### EXAMPLES

### Example 1

### Preparation of Natural Fiber/Polymer Composite

The preparation of natural fiber/polymer composite was carried out in the following processing order, in a ratio of a mixture as described in Table 1. Molding conditions were set to the hot-working pressing temperature of 200° C., the hot-working pressing time of 60 seconds, the cold-working pressing temperature of 23° C., and the cold-working pressing time of 60 seconds.

Processing Order

i) Natural fiber and thermoplastic polymer fiber were processed via mixing, opening, carding, web-forming, needle-punching processes to prepare a natural fiber/polymer felt. ii) 1-30 phr of isocyanate was added on the felt, in a manner of spraying or applying on a roller, to mold the isocyanate in a semi-cured form using a hot-working pressing roller. iii) Thermoplastic polymer powder was applied thereon, curing of the isocyanate was then completed using the hot-working pressing roller, and a thermoplastic polymer powder layer was formed to prepare a natural fiber/polymer composite.

TABLE 1

| Sample | Kenaf | PP | PET | MDI |
|---|---|---|---|---|
| 1 | 40 | 40 | 20 | 0 |
| 2 | | | | 5 |
| 3 | | | | 10 |

### Example 2

### Measuring Tensile Strengths

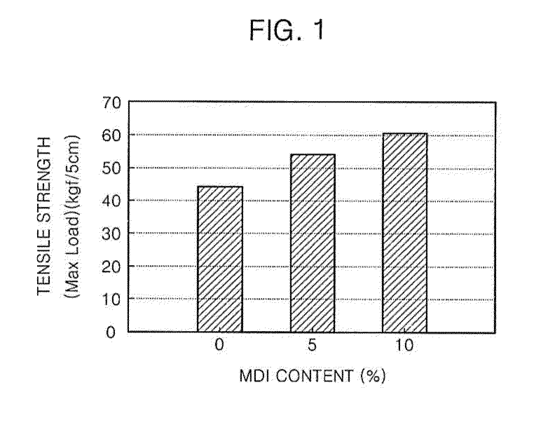

FIG. 1 shows tensile strengths of natural fiber/polymer composites prepared in Example 1, according to contents of isocynate. As illustrated in FIG. 1, the tensile strength with 5% added isocynate is measured to be increased by about 23%, and the tensile strength with 10% added isocynate is measured to be increased by about 38%, in comparison with the tensile strength without addition of isocynate.

### Example 3

### Assessment of Humidity-Resistance

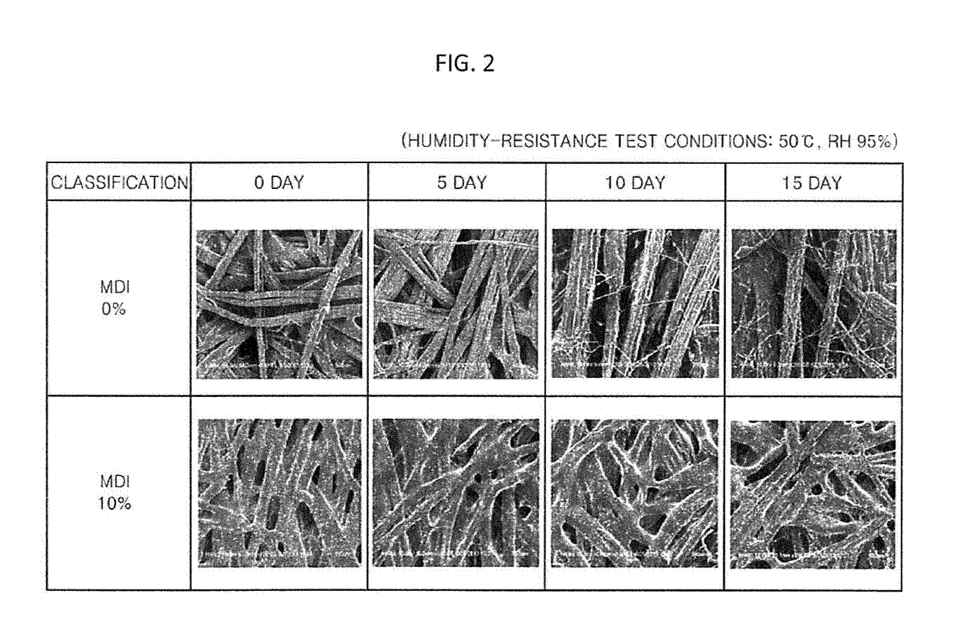

Provided is an assessment of humidity-resistances prior to and after application of an isocyanate layer, regarding the natural fiber polymer composite prepared in Example 1, by measuring the changes in the morphologies and tensile strengths thereof, over humidity-resistance time. FIG. 2 shows the surface morphologies of the natural fiber polymer composite prior to and after addition of isocyanate, over the humidity-resistance time. As illustrated in FIG. 2, it is understood that the surface damage occurred over the humidity-resistance time after the application, is remarkably lower than the damage prior to the application.

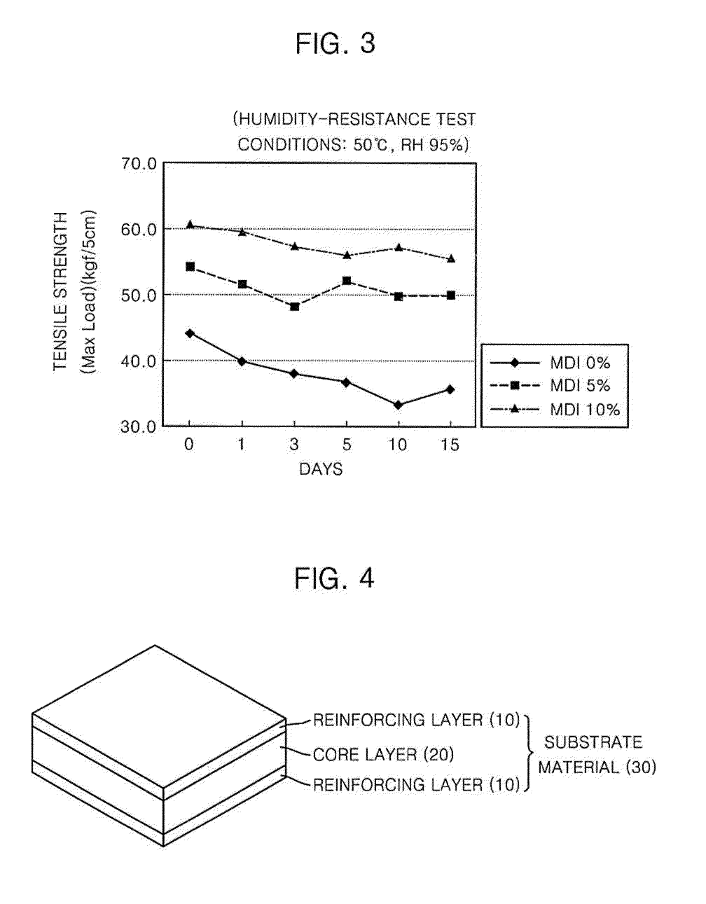

FIG. 3 shows the changes in tensile strengths of a natural fiber polymer composite prior to and after application of an isocyanate layer, over humidity-resistance time. While the maximum tensile strength was decreased by about 25%, at 50° C. and 95% relative humidity after 15 days prior to application of the isocyanate layer, the maximum tensile strength was decreased by about 8% with the addition of isocyanate.

In a comprehensive view of the above results, it is understood that addition of isocyanate is effective for enhancing the tensile strength and humidity-resistance of a natural fiber polymer composite.

The discussion below is offered to illustrate a method for preparing an eco-friendly lightweight substrate material for the automotive interior, using a natural fiber polymer composite as prepared above as a thin film reinforcing layer.

An eco-friendly lightweight substrate material for the automotive interior comprises a foam sheet of a core layer and a thin film reinforcing layer. It was pointed out that known substrate materials for the automotive interior with natural fiber applied, have problems such as deflection and distortion in high temperature and humidity conditions, due to the characteristics of natural fiber having poor water-resistance.

Accordingly, the present invention provides a thermal-laminating process in which humidity-resistance and flexural rigidity are enhanced by continuously stacking an isocyanate-applied natural fiber sheet as a thin film reinforcing layer on a foam sheet.

The preparation of an eco-friendly lightweight substrate material for the automotive interior, according to the present invention, was performed in the following processing order:
i) processing natural fiber and synthetic fiber in a weight ratio of 4:6 in mixing, carding, web-forming, and needle-punching processes to prepare a natural fiber felt;
ii) applying/impregnating isocyanate on the felt in a spraying process and then molding the isocyanate in a semi-cured form using a hot-working pressing roller;
iii) applying high-density polyethylene powder thereon, passing it through a hot-working oven to form a high-density polyethylene powder layer and complete curing reaction of the isocyanate, and then pressing it using a pressing roller to prepare a thin film reinforcing layer (10); and
iv) continuously stacking the thin film reinforcing layer (10) on both sides of a polypropylene foam sheet that is a core layer (20) by thermal-laminating to prepare an eco-friendly lightweight substrate material for the automotive interior (30).

Table 2 shows the humidity-resistance flexural rigidity at room temperature and the humidity-resistance deflection extent of the specimens prepared according to the present invention, in comparison to conventional specimens. As compared in Table 2, with added isocynates each of 12 g/m² and 24 g/m², the states of flexural rigidity were increased respectively by 60% and 85%, the humidity-resistance flexural rigidities were increased respectively by about 90% and 110%, and the humidity-resistance deflection extents were decreased respectively by 50% and 80%, resulting in remarkable enhancement of humidity-resistance and mechanical characteristics.

In comparison with conventional heavyweight substrate materials, it is understood that the present invention is able to bring weight lightening of an eco-friendly lightweight substrate material into realization, since it shows excellent humidity-resistant with added isocynate of 12 g/m², and shows remarkable enhancement in humidity-resistance and flexural rigidity with added isocynate of 24 g/m², while the weight of the substrate material is lower than that of the conventional materials by 20%.

The measurement of the flexural rigidity was performed based on ASTM D790, in the conditions of the specimen size of “50 mm×150 mm×thinkness”, the testing rate of 5 mm/min, and the span width of 100 mm; and the test for the humidity-resistance flexural rigidity was carried out in the above conditions after allowing the specimen for 24 hours at 50° C., 95 RH % humidity and then stabilizing it for an hour at 23° C., 95 RH % humidity.

The measurement of the humidity-resistance deflection extent (L) was measured by fixating 70 mm in the distal end of a specimen of 50 mm×150 mm×thickness and 660 g/m² in weight; placing a weight of 40 mm×60 mm in size and 34.2 g in weight on the opposite part; and measuring the difference between an initial height (L1) from the bottom to the lower part of the specimen and a subsequent height (L2) measured after allowing the specimen for 7 hours at 50° C. and 95RH % humidity, such that the humidity-resistance deflection extent (L) is calculated by the change in the heights prior to and after applying humidity.

humidity-resistance deflection extent (L)=initial height (L1)−subsequent height (L2)

TABLE 2

| | | Conventional 1 | Conventional 2 | | |
|---|---|---|---|---|---|
| Classification | | (heavyweight) | (lightweight) | Example 1 | Example 2 |
| Foam Sheet (PP FOAM) | | 25 times/ | 25 times/ | 25 times/ | 25 times/ |
| | | 4.5 mm | 5.0 mm | 4.5 mm | 4.5 mm |
| | | 200 g/m² | 180 g/m² | 180 g/m² | 180 g/m² |
| Natural Fiber/ | | 270 | 160 | 160 | 160 |
| Synthetic Fiber (g/m²) | | | | | |
| HDPE Powder (g/m²) | | 50 | 80 | 68 | 56 |
| Isocyanate (g/m²) | | — | — | 12 | 24 |
| Total Weight (g/m²) | | 840 | 660 | 660 | 660 |
| Flexural | State | 2.2 | 1.3 | 2.1 | 2.4 |
| Rigidity | | | | | |
| (kgf/5 cm) | | | | | |
| | Humidity- | 1.9 | 1.0 | 1.9 | 2.1 |
| | Resistance | | | | |

| | | | | |
|---|---|---|---|---|
| Humidity-Resistance | 2.5 | 4.0 | 2.0 | 0.8 |
| Deflection Extent (mm) | | | | |

### CODE INDICATION

10: a thin film reinforcing layer

20: a core layer

30: an eco-friendly lightweight substrate material for the automotive interior

1. A method for preparing a natural fiber polymer composite, characterized in the steps comprising:
preparing a felt consisting of a mixture of natural fiber and thermoplastic polymer fiber;
spraying or applying liquid isocyante on the felt; and
curing the felt with the liquid isocyante by hot-working pressing to mold a sheet-shaped form.

2. The method of claim 1, characterized in that the natural fiber is cellulose-based fiber.

3. The method of claim 1, characterized in that the isocyante is methylene diphenyl di-isocyanate (MDI) or toluene di-isocyanate (TDI).

4. The method of claim 1, characterized in that the step of curing is characterized in that the isocyanate is processed by the hot-working pressing to mold the sheet-shaped form in a semi-cured state; and after applying thermoplastic polymer powder on the surface of the felt, curing of the isocyanate is completed by cold-working pressing.

5. A method for preparing a substrate material for the automotive interior, characterized in the steps comprising:
a first step of preparing a felt using natural fiber and synthetic fiber;
a second step of applying isocyanate on the felt and then molding the isocyanate in a semi-cured state using a hot-working pressing roller to prepare a sheet;
a third step of forming a thermoplastic powder layer on the surface of the sheet and completing curing reaction of the isocyanate by applying thermoplastic powder on the sheet and heating to prepare a thin film reinforcing layer using pressing; and
a forth step of continuously stacking the prepared thin film reinforcing layer on one or both sides of a core layer consisting of the foam sheet in a thermal-laminating process.

6. The method of claim 5, characterized in that the thermoplastic foam sheet is polypropylene, polyethylene, or polyester; the foaming magnification of the sheet is 5 to 40 times; and the thickness of the sheet is 2 to 10 mm

7. The method of claim 5, characterized in that the isocyante is methylene diphenyl di-isocyanate (MDI) or toluene di-isocyanate (TDI).

8. The method of claim 5, characterized in that the weight of the isocyanate incorporated in thin film reinforcing layer is 5 g/m² to 100 g/m².

9. The method of claim 5, characterized in that the thickness of thin film reinforcing layer is 0.5 to 2 mm; and the weight of the layer is 120 g/m² to 700 g/m².

10. The method of claim 5, characterized in that one or more synthetic fibers for use in the thin film reinforcing layer are selected from polypropylene fiber of 30-100 mm in length, core-sheath low melting point polyester fiber, polyester fiber, polyethylene fiber, acryl fiber, or biodegradable fiber.

11. The method of claim 5, characterized in that the content of natural fiber for use in the thin film reinforcing layer is 30-70% by weight.

12. The method of claim 5, characterized in that one or more natural fibers for use in the thin film reinforcing layer are selected from kenaf of 30-100 mm in length, jute, linum, bamboo, or sisal.

13. The method of claim 5, characterized in that one or more for use in the thermoplastic powder are selected from low-density polyethylene, high-density polyethylene, or polypropylene.

14. An eco-friendly lightweight substrate material for the automotive interior, characterized in being prepared by the method of any one of claim 5.

15. The substrate material of claim 14, characterized in that a humidity-resistance flexural rigidity is greater than 1.0 kgf/5 cm, and a humidity-resistance deflection extent (L) is equal to, or less than 2.0 mm by the following standards, wherein the humidity-resistance flexural rigidity (kgf/5 cm) is the measured value, regarding a specimen of “50 mm×150 mm×thickness” and “660 g/m²” in weight, calculated based on ASTM D790 after allowing the specimen for 24 hours at the testing rate of 5 mm/min, the span width of 100 mm, 50° C., and 95 RH % humidity, and then stabilizing the specimen for an hour at 23° C. and 95 RH % humidity; and
wherein the humidity-resistance deflection extent (L) is measured by fixating 70 mm in the distal end of a specimen of “50 mm×150 mm×thickness” and “660 g/m²” in weight; placing a weight of 40 mm×60 mm in size and 34.2 g in weight on the opposite part; and measuring the difference between an initial height (L1) from the bottom to the lower part of the specimen and a subsequent height (L2) measured after allowing the specimen for 7 hours at 50° C. and 95 RH % humidity (i.e. L=L1−L2).
